(19) United States
(12) Patent Application Publication
(10) Pub. No.: US 2006/0180522 A1
(43) Pub. Date: Aug. 17, 2006

(54) Method and apparatus for sorting plastic and paper waste

(76) Inventor: Hermannus Johannes Maria Legtenberg, Winschoten (NL)

Correspondence Address: PEARNE & GORDON LLP, 1801 EAST 9TH STREET, SUITE 1200, CLEVELAND, OH, 44114-3108, US

(21) Appl. No.: 11/313,389

(22) Filed: Dec. 21, 2005

Related U.S. Application Data
(60) Provisional application No. 60/639,660, filed on Dec. 28, 2004.

(51) Int. Cl. B07C 5/00

(52) U.S. Cl. 209/639; 209/640

(57) ABSTRACT

Sorting a stream of mingled paper and plastic items (2, 3) fed to a release area (6) spaced above a hitting area (7). The items (2, 3) are released from the release area (6) causing the items to fall towards the hitting area (7) in at least one falling direction (13). In the hitting area, the items (2, 3) in the hitting area (7) are hit in at least one direction (25, 26) diverging from the at least one falling direction (13) by a horizontal directional component. A first fraction of the items (2, 3) hit in the hitting area (7), at least relatively rich in plastic items (2) drops to a first receiving window (14); and a second fraction of the items (2, 3) hit in the hitting area (7), at least relatively rich in paper items (3) drop to a second receiving window (15), the first receiving window (14) being located horizontally more remote from the hitting area (7) and/or vertically higher than the second receiving window (15). An apparatus for sorting a stream including mingled plastic and paper items (2, 3) is also described.

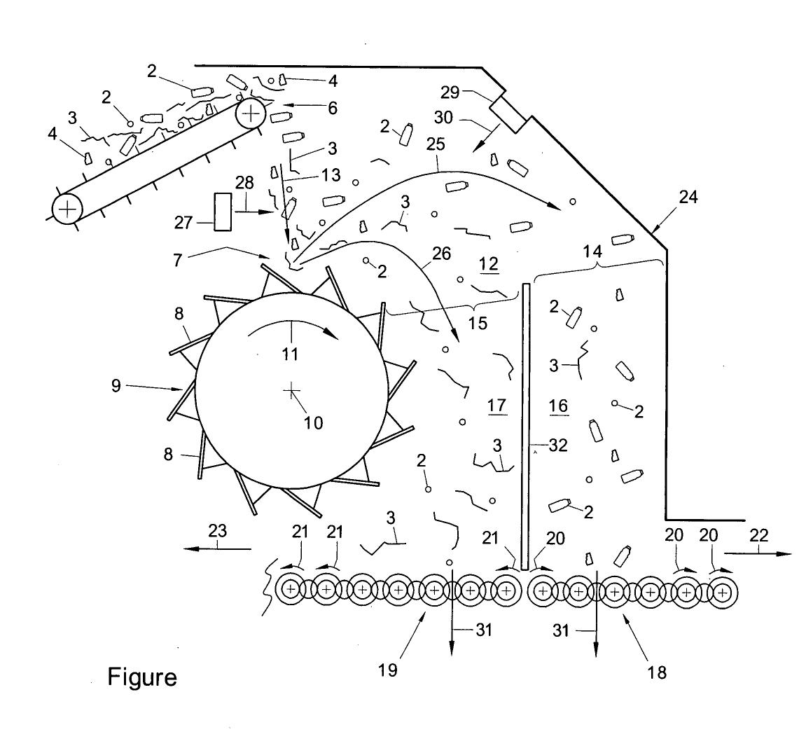

This application claims the benefit of U.S. Provisional Patent App. No. 60/639,660 filed Dec. 28, 2004, the contents of which are incorporated herein by reference.

### TECHNICAL FIELD AND BACKGROUND ART

In many municipalities, waste paper, cardboard and plastic are collected in mingled form. For the sake of recycling, however, it is preferred to have waste plastic separated from waste paper and cardboard to allow useful recycling of such material. The invention relates to a method and an apparatus for sorting waste paper from waste plastic.

In U.S. Pat. No. 3,757,946, a method for sorting a stream including mingled plastic and paper items is described in which the mingled paper and plastic items are fed to a release area spaced above a hitting area, the items from are released above the hitting area causing the items to fall towards the hitting area. In the hitting area, the items are hit in a direction diverging from the falling direction by a horizontal directional component. A first fraction of the items hit in the hitting area, at least relatively rich in plastic items drops to a first receiving window; and a second fraction of the items hit in the hitting area, at least relatively rich in paper items drops to a second receiving window. The first receiving window is located horizontally more remote from the hitting area than the second receiving window.

### SUMMARY OF THE INVENTION

It is an object of the invention to more effectively sort at least waste paper from at least waste plastic in a mingled stream that avoids the disadvantages of air flushing.

According to the present invention, this object is achieved by providing a method for sorting a stream including mingled plastic and paper items, comprising:

feeding the mingled paper and plastic items to a release area spaced above a hitting area;

releasing the items from said release area causing the items to fall towards the hitting area in at least one falling direction; and

hitting the items in the hitting area in at least one direction diverging from the at least one falling direction by a horizontal directional component;

wherein a first fraction of the items hit in the hitting area, at least relatively rich in plastic items drops to a first receiving window;

wherein a second fraction of the items hit in the hitting area, at least relatively rich in paper items drops to a second receiving window, the first receiving window being located horizontally more remote from the hitting area and/or vertically higher than the second receiving window; and

wherein items falling to the hitting area are non-selectively subjected to an air flow transverse to the at least one falling direction, said air flow causing the falling directions of the items to be deflected to different extents, said differences in the extent of deflection causing positions in the hitting area where the items are hit to vary in at least the direction of deflection, and the direction in which each of the items is hit being lower, the more the falling direction of the respective items has been deflected before the respective item has been hit.

The invention may also be embodied in an apparatus for sorting a stream including mingled plastic and paper items, comprising:

a conveyor for feeding the mingled paper and plastic items, the conveyor having a downstream end in a release area spaced above a hitting area such that items released in said release area fall towards the hitting area in at least one falling direction;

at least one hitting blade drivable for movement through the hitting area in at least one direction diverging from the at least one falling direction by a horizontal directional component for hitting the items in the hitting area into a sorting space in at least one hitting direction diverging from the at least one falling direction by a horizontal directional component;

a first receiving window; and

a second receiving window;

wherein the first receiving window is located horizontally more remote from the hitting area and/or vertically higher than the second receiving window,

wherein separate receiving areas are located downstream of said windows,

wherein the sorting space is arranged such that, in operating condition, all paper waste is allowed to drop out of said sorting space, and

wherein a fan arranged for driving an air flow transverse to the at least one falling direction with a directional component parallel to the direction of movability of the hitting blades through the hitting area; the hitting blades being movable along a trajectory curved away from the release area.

The air flow tends to deflect the falling direction of relatively light film materials, such as paper, more than the falling direction of relatively heavy items, such as plastic bottles. The differences in the extent of deflection causes positions in the hitting area where the items are hit to vary in at least the direction of deflection. The direction in which each of the items is hit is lower, the more the falling direction of the respective items has been deflected before the respective item has been hit. Thus, the air-flow enhances the sorting action achieved in the hitting area by causing the relatively heavy plastic items to be generally hit in a direction pointing higher than the direction in which items of paper are generally hit. This enhances the extent to which plastic items are hit higher and further into the sorting space than paper items and therefore the effectiveness of the sorting process.

Particular embodiments of the invention are set forth in the dependent claims.

Further aspects, effects and details of the invention are set forth in the detailed description with reference to an example shown in the drawing.

### BRIEF DESCRIPTION OF THE DRAWING

The drawing is schematic side view of an example of an apparatus according to the invention in operation.

### DETAILED DESCRIPTION OF THE PREFERRED EMBODIMENTS OF THE INVENTION AND MODES FOR CARRYING OUT THE INVENTION

In the drawing, an example of apparatus according to the invention for sorting a stream of co-mingled waste. Co-mingled waste is waste collected in a mixed form that is destined for recycling and generally has been presorted by collection in dustbins separate from other waste, such as compostable waste. Accordingly, the mixture of paper and plastic waste is generally quite dry and contains relatively little other waste. In practice, a large portion of the plastic items is formed by plastic bottles of the type used for packaging water or other drinkable liquids. Some of the plastic items have been indicated by reference numerals 2. Paper items typically appear in a large variety and typically include for instance remainders of printed matter or packages. Some of the paper items have been indicated by reference numerals 3. The co-mingled waste according to the present example also includes a substantial portion of glass items, of which some have been designated by reference numerals 4.

The apparatus includes a conveyor 5 for feeding the mingled paper and plastic items 2-4. The conveyor 5 has a downstream end in a release area 6 spaced above a hitting area 7.

A number of hitting blades 8 are mounted to a rotor 9. The hitting blades are distributed about the circumference of the rotor 9. The rotor is drivable for rotation about a horizontal axis 10 in a sense of rotation indicated by an arrow 11. The sense of rotation 11 is such that a section of the circumference of the rotor 9 facing the release area moves with a horizontal directional component in the direction of a sorting space 12 bounded by a wall 24.

When the rotor 9 is driven, the hitting blades 8 are driven for movement through the hitting area 7 in directions diverging from the falling directions (arrow 13) by a horizontal directional component in the direction of the sorting space 12.

In the sorting space 12, a first receiving window 14 and a second receiving window 15 can be distinguished. The first receiving window 14 is located horizontally more remote from the hitting area 7 than the second receiving window 15. Receiving areas 16, 17 are located under the receiving windows 14, 15 for receiving items 2-4 that have dropped through the receiving windows 14, 15. The receiving areas 16, 17 are mutually separated by a wall 18.

Bottoms of the receiving areas 16, 17 are formed by roller conveyors 18, 19 that are drivable for rotation in different senses (arrows 20, 21) for transport of material on the conveyor in different directions (arrows 22, 23).

The sorting space 12 is arranged such that, in operation, all paper waste 3 (disregarding insignificant amounts of waste that will in practice kling to surfaces of the apparatus) is allowed to drop out of the sorting space 12, i.e. there are no means for preventing a substantial portion of the paper waste from dropping out of the sorting space, such as means for generating an airflow in the sorting chamber 12 that causes an airborne fraction of the waste to float out of the sorting space or mechanical catchers that refrain paper items from dropping out of the sorting space 12.

In operation, the mingled paper, plastic and glass items 2-4 are fed to the release area 6 spaced above the hitting area 7. From the release area 6 the items 2-4 are caused to fall towards the hitting area 7 in the falling directions generally designated by the arrow 13.

Then the items are subjected to the operation causing the plastic items 2 to be, at least to a large extent, sorted from the paper items 3 by hitting the items 2-4 in the hitting area 7 in directions generally designated by arrows 25, 26 diverging from the falling directions 13 by a horizontal directional component in the direction of the sorting space 12. When hit by one of the hitting blades 8, the relatively hard plastic items 2 bounce efficiently away from the hitting blades and accordingly, a relatively high velocity is imparted upon the plastic items 2 when these are hit by the hitting blades 8. This in turn, causes the plastic items 2 to be propelled relatively far into the sorting space 12; generally more along a trajectory indicated by the arrow 25 than along a lower trajectory indicated by the arrow 26. Conversely, paper items 3 that are hit exhibit no or virtually no bouncing behavior and are therefore propelled into the sorting space 12 with a relatively low velocity. In the apparatus according to the present example, this will in practice be approximately the circumferential velocity of the hitting blades 8. This difference in bouncing behavior causes a first fraction of the items 2-4 hit in the hitting area 7, which is at least relatively rich in plastic items 2 to drop to the first receiving window 14 and a second fraction of the items 2-4 hit in the hitting area 7, which is at least relatively rich in paper items 3 to drop to the second receiving window 15 which is located horizontally less remote from the hitting area 7 than the first receiving window 14.

Accordingly, the fraction at least relatively rich in plastic items 2 is received in the first receiving area 16, from which it may be transported away in the direction indicated by arrow 22 and the fraction at least relatively rich in paper items 3 is received in the second receiving area 17, from which it may be transported away in the direction indicated by arrow 23.

It is observed that, instead of or in addition to being located horizontally more remote from the hitting area, the first receiving window may also be positioned for receiving the fraction more rich in plastic material than the fraction received via the second window, by positioning the first window in a position vertically higher than the second receiving window. Furthermore, the receiving windows are preferably positioned such that one of the windows does not partially cover the other one of the receiving windows and its full surface size is available for receiving waste items.

The rotor 9 forms a suspension of the hitting blades 8 that guides the hitting blades 8 along a circulating path including the hitting trajectory through the hitting area 7. This allows the hitting blades 8 to bee guided by a simple and efficient suspension and, as such, the circulating movement of the hitting blades 8 is also advantageous for passing the hitting blades 8 through the hitting area 7 with enough velocity without requiring a complicated drive and without imparting substantial vibratory forces to the apparatus.

A fan 27 is arranged for driving an air flow (represented by arrow 28) transverse to the falling directions (arrow 13) with a directional component parallel to the direction of movability of the hitting blades 8 through the hitting area 7. Furthermore, the way the hitting blades 8 are suspended provides that the hitting blades 8 are movable along a trajectory that is curved away from the release area 6. The air flow tends to deflect the falling direction of relatively light items more than the falling direction of relatively heavy items.

The cross-wind 28 generated by the fan 27, to which the items 2-4 are non-selectively subjected, causes the falling directions 13 of the items 2-4 to be deflected to different extents. The differences in the extent of deflection causes positions in the hitting area 7 where the items 2-4 are hit to vary in at least the direction of deflection. Since the trajectory of the hitting blades 8 in the hitting area 7 is curved away from the release area 6, the direction in which each of the items 2-4 is hit is lower, the more the falling direction 13 of the respective items 2-4 has been deflected before the respective item 2-4 has been hit. Thus, the cross-wind 28 enhances the sorting action achieved in the hitting area 7 by causing the relatively heavy plastic items 2 to be generally hit in a direction pointing higher than the direction in which paper items 3 are generally hit. This enhances the extent to which plastic items 2 are hit higher and further into the sorting space 2 than paper items 2 and therefore the effectiveness of the sorting process.

The circulating motion of the blades 8 also contributes to the air flow across the path along which the items fall to the launching area, in particular if the blades have closed surfaces. The airflow entrained by the circulating hitting blades 8 even causes a substantial portion of the paper items to fully or mainly entrained thereby, without being hit by one of the hitting blades 8.

Although the movement of the blades may be the only means for driving an airflow across the path along which the items fall to the launching area, it is preferred that, as in the present example, the fan 27 is separate from the hitting blades 8.

By providing that the transverse air flow 28 is generated by a fan 27 separate from the hitting blades 8, the transverse air flow 28 can be maintained effectively in areas remote from the rotor 9 as well. This allows to deflect the falling directions 13 of items 2-4 falling from the release area 6 over a large portion of the falling trajectory and accordingly have a large deflecting effect on the falling direction 13 and an accordingly large variation in the extent to which items 2-4 with different weights and aerodynamic characteristics are deflected and an accordingly large variation in the direction into which the items 2-4 are hit.

For an effective separation based on differences in bouncing properties, the hitting blades 8 are preferably drivable with a velocity of at least 7 m/s and more preferably of at least 10 m/s.

The apparatus is further equipped with a fan 29 arranged for driving an air flow represented by arrow 30 having a directional component opposite to the directions 25, 26 in which the items 2-4 are hit. This fan 29 is positioned in an area spaced from the hitting area 7 in the directions 25, 26 in which the items 2-4 are hit.

The air flow 30 generated by the fan 29 urges items down from their ballistic trajectories and this effect is larger, the lighter the items are. Paper items 3 which already tend to fly less far than plastic items, because paper items exhibit comparatively little tendency to bounce off the hitting blades 8, are relatively light and therefore deflected downwardly more from their, generally already lower ballistic trajectories than plastic items 2, which are relatively heavy. Accordingly, the air flow enhances separation of paper from plastic.

The sorting effectiveness may be enhanced further by withdrawing air at the side of the trajectory of the hitting blades where the hitting blades 8 return to the hitting area. This causes the air flows 28 and 30 to be bent along the trajectory of the hitting blades 8, which provides further guidance of the lighter items 3 to the second receiving window 15.

The release area 6 is located more than 1 m and preferably at least 1.5 m above the hitting area 7. Since the items 2-4 fall from the release area towards the hitting area over a height of at least 1 m and preferably at least 1.5 m, the items 2-4 falling from the release area 6 towards the hitting area 7 achieve a high velocity. This, in turn allows to obtain a high processing capacity while ensuring that the items 2-4 reach the hitting area 7 as a stream with an average thickness in the hitting direction 25, 26 smaller than or equal to a single layer of items 2-4. That the items 2-4 reach the hitting area as a generally single layer of products 2-4 is advantageous to prevent that plastic items 2 are prevented from bouncing off the hitting blades 8 by paper items 3 forming a cushion between the plastic item 2 and the hitting blade 8 or by paper items 3 that are in the way of the plastic items 2 that are hit into the sorting space 12 along the higher trajectories such as trajectory 25.

Although the hitting blades 8 may in principle have a hitting surface that is soft and elastic, for the processing of co-mingled waste including substantial amounts of glass items, it is advantageous if the surfaces of the hitting blades 8 are hard and stiff enough to cause glass items 4 hit by the hitting blades to be crushed. The glass can subsequently be separated from the other materials downstream of the receiving windows 14, 15 by sieving. According to the present example, the sieving may be carried out by the roller conveyors 18, 19. In the drawings, glass dropping through the roller conveyors 18, 19 is represented by arrows 31.

From the foregoing, it will be clear to the skilled person, that within the framework of invention as set forth in the claims also many variations other than the examples described above are conceivable.

What is claimed is:

1. A method for sorting a stream including mingled plastic and paper items, comprising:
feeding the mingled paper and plastic items to a release area spaced above a hitting area;
releasing the items from said release area causing the items to fall towards the hitting area in at least one falling direction; and
hitting the items in the hitting area in at least one direction diverging from the at least one falling direction by a horizontal directional component;
wherein a first fraction of the items hit in the hitting area, at least relatively rich in plastic items drops to a first receiving window;
wherein a second fraction of the items hit in the hitting area, at least relatively rich in paper items drops to a second receiving window, the first receiving window being located horizontally more remote from the hitting area and/or vertically higher than the second receiving window; and
wherein items falling to the hitting area are non-selectively subjected to an air flow transverse to the at least one falling direction, said air flow causing the falling directions of the items to be deflected to different extents, said differences in the extent of deflection causing positions in the hitting area where the items are hit to vary in at least the direction of deflection, and the direction in which each of the items is hit being lower, the more the falling direction of the respective items has been deflected before the respective item has been hit.

2. A method according to claim 1, wherein the items are hit by hitting blades circulating along a path including said hitting area.

3. A method according to claim 1, wherein the items are hit by hitting blades moving along a trajectory curved away from the release area and wherein the transverse air flow has a directional component parallel to the direction of movement of the hitting blades along the trajectory through the hitting area.

4. A method according to claim 1, wherein the transverse air flow is generated by a fan separate from the hitting blades.

5. A method according to claim 1, wherein the items are hit with a velocity of at least 7 m/s and preferably at least 10 m/s.

6. A method according to claim 1, wherein an air flow having a directional component opposite to the at least one direction in which the items are hit is maintained in an area spaced from the hitting area in the at least one direction in which the items are hit.

7. A method according to claim 1, wherein the items falling from the release area towards the hitting area form a stream with an average thickness in the hitting direction smaller or equal to a single layer of items.

8. A method according to claim 7, wherein the items fall from the release area towards the hitting area over a height of at least 1 m.

9. A method according to claim 1, wherein the items include items of glass, said glass items being crushed when hit in the hitting area and sieved out downstream of said receiving windows.

10. An apparatus for sorting a stream including mingled plastic and paper items, comprising:
a conveyor for feeding the mingled paper and plastic items, the conveyor having a downstream end in a release area spaced above a hitting area such that items released in said release area fall towards the hitting area in at least one falling direction;
at least one hitting blade drivable for movement through the hitting area in at least one direction diverging from the at least one falling direction by a horizontal directional component for hitting the items in the hitting area into a sorting space in at least one hitting direction diverging from the at least one falling direction by a horizontal directional component;
a first receiving window; and
a second receiving window;
wherein the first receiving window is located horizontally more remote from the hitting area and/or vertically higher than the second receiving window,
wherein separate receiving areas are located downstream of said windows,
wherein the sorting space is arranged such that, in operating condition, all paper waste is allowed to drop out of said sorting space, and
wherein a fan arranged for driving an air flow transverse to the at least one falling direction with a directional component parallel to the direction of movability of the hitting blades through the hitting area; the hitting blades being movable along a trajectory curved away from the release area.

11. An apparatus according to claim 10, further comprising a suspension for guiding of the hitting blades along a circulating path including said trajectory.

12. An apparatus according to claim 10, wherein the fan is separate from the hitting blades.

13. An apparatus according to claim 10, wherein the hitting blades are drivable with a velocity of at least 7 m/s and preferably at least 10 m/s.

14. An apparatus according to claim 10, further comprising a fan arranged for driving an air flow having a directional component opposite to the at least one direction in which the items are hit, in an area spaced from the hitting area in the at least one direction in which the items are hit.

15. An apparatus according to claim 10, wherein the release area is located at least 1 m above the hitting area.

16. An apparatus according to claim 10, wherein the hitting blades have a hitting surface hard en rigid enough for breaking glass items hit thereby, further comprising a sieve for sieving glass downstream of said receiving windows.
